(19) United States
(12) Patent Application Publication
(10) Pub. No.: US 2011/0168696 A1
(43) Pub. Date: Jul. 14, 2011

(54) Computer With Electric Heating Unit

(75) Inventor: Wen-Hung Huang, Taipei County (TW)

(73) Assignee: HANNSPREE, INC., Taipei City (TW)

(21) Appl. No.: 12/776,595

(22) Filed: May 10, 2010

(30) Foreign Application Priority Data
Jan. 13, 2010 (TW) 099100852

(51) Int. Cl. H05B 6/04

(52) U.S. Cl. 219/660

(57) ABSTRACT

The present invention discloses a computer with an electric heating unit, wherein the casing of a computer unit is integrated with an electric heating unit. The electric heating unit has an electric heating plane on the casing. The electric heating plane heats a heatable article placed on the casing. A support device is arranged on the casing to hold a heatable article preventing the heatable article from being accidentally knocked over.

### BACKGROUND OF THE INVENTION

1. Field of the Invention

The present invention relates to a computer, particularly to a computer with an electric heating unit on the casing thereof, whereby the user can heat a heatable article on the casing of the computer unit.

2. Description of the Related Art

With the advance of science and technology, the electrical devices, such as computers, televisions and refrigerators, have become indispensable devices at home and office. The electromagnetic plate is a compact and portable oven, which cooks or heats up food conveniently and is widely accepted by consumers.

Those who live in an apartment or in small space should prefer a compact complex product, which integrates several functions in a single device. Therefore, many manufacturers propose their multi-function integrated products, which are convenient and compact for the users. Although the computer and the electromagnetic plate are each indispensable for many people, current market still lacks a product that integrates both.

### SUMMARY OF THE INVENTION

The primary objective of the present invention is to provide a design integrating a computer with an electric heating unit, whereby the computer not only can function as a computer but also can cook or heat up food, and whereby to add the value of the computer and facilitate the convenience to the user.

Another objective of the present invention is to provide a computer with an electric heating unit, whereby the user need not purchase an electromagnetic plate but can heat or cook food with the built-in electric heating unit, and saves the space relatively.

To achieve the abovementioned objectives, the present invention proposes a computer with an electric heating unit, which comprises

a computer unit having a casing with a flat plane;

an electric heating unit arranged inside the casing and electrically connected to the computer unit, wherein the electric heating unit has an electric heating plane arranged on the flat plane and used to heat a heatable article placed on the flat plane; and

a controller controlling the operation of the electric heating unit.

To prevent the heatable article on the casing from being accidentally knocked over, a support device is added to the casing. The support device includes a first support member and a second support member respectively coupled to two sides of the casing to hold the heatable article on the flat plane.

The support device further comprises a first expanding member and a second expanding member. One end of the first expanding member is coupled to the casing, and the other end of the first expanding member is coupled to the first support member, whereby the first support member can be expanded. One end of the second expanding member is coupled to the casing, and the other end of the second expanding member is coupled to the second support member, whereby the second support member can be expanded. When the water contained in the heatable article is heated and gradually evaporated, the weight of the heated object is gradually decreased. When the weight of the object is decreased to such an extent that it is unable to overcome the upward pushing force of the first and the second expanding members, the upward pushing force makes the first and second support members lift up the heatable article. Thus, the heatable article is separated from the electric heating plane, no more heated by the electric heating plane.

### BRIEF DESCRIPTION OF THE DRAWINGS

FIG. 1 is a perspective view schematically showing a computer with an electric heating unit according to one embodiment of the present invention;

FIG. 2 is a sectional view schematically showing a computer with an electric heating unit according to one embodiment of the present invention;

FIG. 3 is a top view schematically showing a computer with an electric heating unit according to one embodiment of the present invention;

FIG. 4 is a rear view schematically showing a computer with an electric heating unit according to one embodiment of the present invention;

FIG. 5 is a diagram schematically showing that a heatable article is heated by a computer with an electric heating unit according to one embodiment of the present invention;

FIG. 6 is a diagram schematically showing that a support device is added to a computer with support members folded according to one embodiment of the present invention;

FIG. 7 is a diagram schematically showing that a support device is added to a computer with support members expanded to hold a heatable article on the casing according to one embodiment of the present invention; and

FIG. 8 is a diagram schematically showing that a support device is added to a computer with support members lifting up a heatable article from the casing according to one embodiment of the present invention.

### DETAILED DESCRIPTION OF THE INVENTION

The technical contents of the present invention are described in detail with the embodiments.

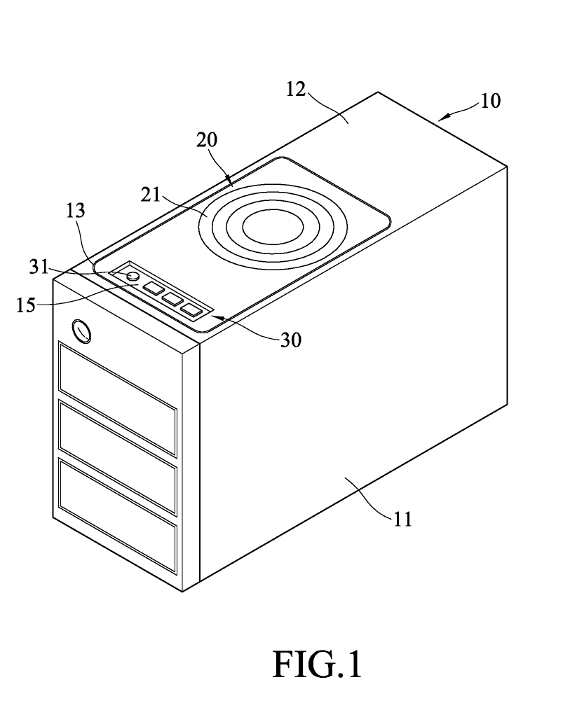

Referring to FIG. 1, a perspective view schematically shows a computer with an electric heating unit according to one embodiment of the present invention. The computer with an electric heating unit comprises a computer unit 10, an electric heating unit 20 and a controller 30. The computer unit 10 has a casing 11 with a rectangular parallelepiped shape. The casing 11 has a flat plane 12 on the top thereof. However, the present invention does not limit the shape of the casing 11 to be a rectangular parallelepiped shape. The present invention only requires the casing 11 to have a shape able to stably placing a heatable article on the flat plane 12.

The electric heating unit 20 is integrated with the casing 11 of the computer unit 10. The electric heating unit 20 has an electric heating plane 21 arranged on the flat plane 12. A heatable article is placed on the electric heating plane 21 to contact with the heating plane 21 of the heating unit 20 and heated by the electric heating plane 21. The electric heating plane 21 may be a plane having an electromagnetic heating coil or a heat conducting plate.

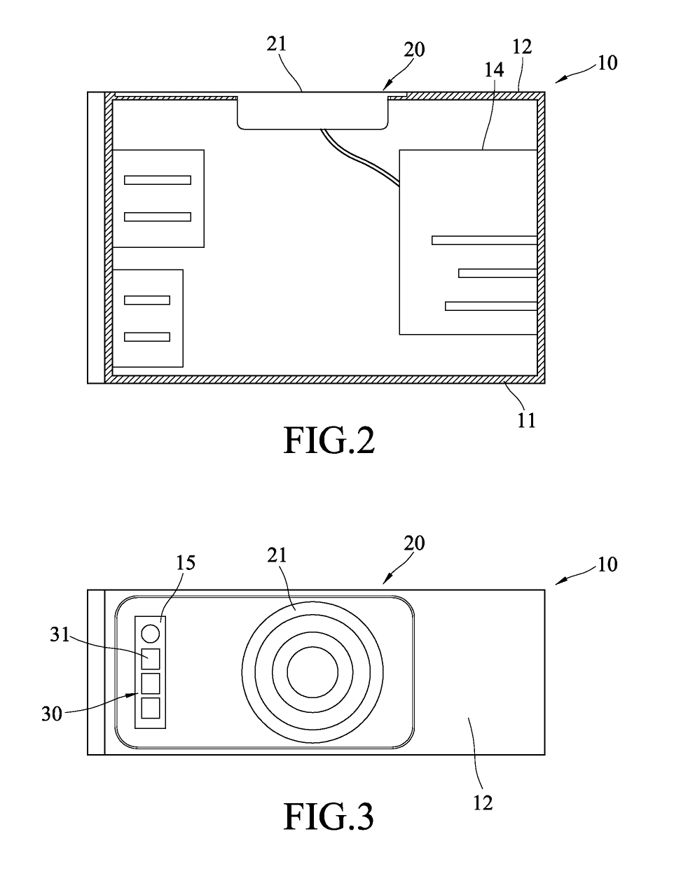

Referring to FIG. 2, the electric heating unit 20 is arranged inside the casing 11 and below the flat plane 12. The casing 11 has an opening 13 which receives the electric heating unit 20 and reveals the electric heating plane 21. The electric heating unit 20 is electrically connected with a power supply 14 arranged inside the computer unit 10 and powered by the power supply 14.

Referring to FIG. 3, in the present invention, the controller 30 is arranged on the casing 11 and electrically connected with the electric heating unit 20. In one embodiment, the controller 30 is integrated on the flat plane 12. In another embodiment, the controller 30 is arranged on a surface where the user can easily operate the controller 30. In yet another embodiment, the controller 30 has a recessed area 15, and the controller 30 is arranged inside the recessed area 15 to avoid accidentally pressing the controller 30.

Referring to FIG. 1 and FIG. 3, the controller 30 includes at least one operating element 31. The operating elements 31 may be but is not limited to switches or press buttons. In another embodiment, the controller 30 further has a display, such as LCD display (not shown in the drawings) to display the status of the electric heating unit 20.

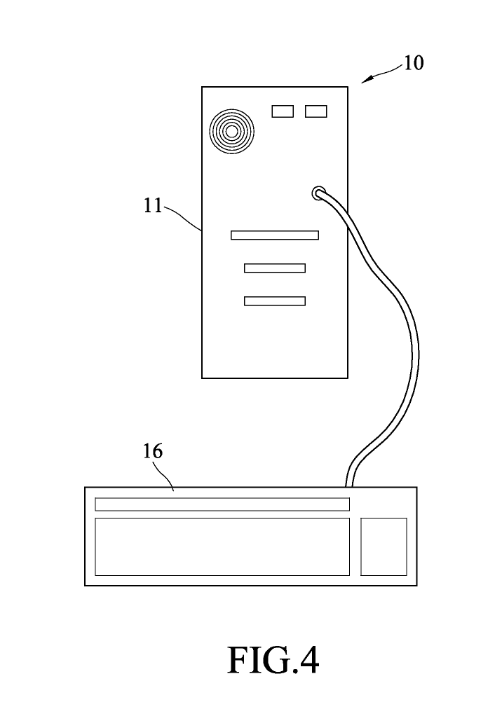

Referring to FIG. 4, a rear view schematically shows a computer with an electric heating unit according to a further embodiment of the present invention. In the further embodiment, an external keyboard 16, which is electrically connected to the computer unit 10, instead of the controller 30, it is built in the casing 11 for controlling the electric heating unit 20. In such a case, the keys of the keyboard 16 replace the operating elements 31 to operate the electric heating unit 20.

In a further another embodiment, a wireless controller (not shown in the drawings) replaces the controller 30 or the keyboard 16 to control the electric heating unit 20.

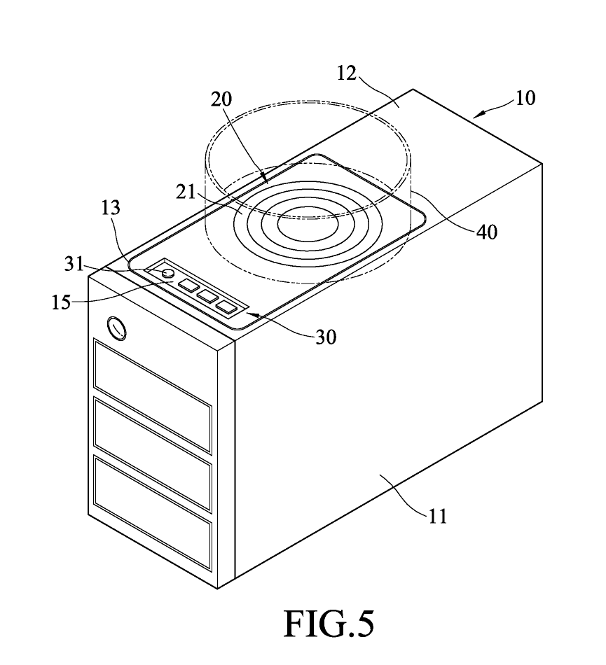

Referring to FIG. 5, a diagram schematically shows that a heatable article is heated by a computer with an electric heating unit according to the present invention. The heatable article 40 may be a heat-resisting and thermally-conductive container, such as a ceramic container. The heatable article 40 is placed on the flat plane 12 of the casing 11 and arranged to contact the electric heating plane 21. The energy produced by the electric heating plane 21 will be transferred to the heatable article 40, and the object inside the heatable article 40 is thus heated.

From the above description, it is known that the present invention artfully integrates a computer unit 10 with an electric heating unit 20, whereby the computer unit 10 not only can perform the functions of a conventional computer but also can cook or heat up food. Therefore, the present invention not only adds the value of a computer but also saves space.

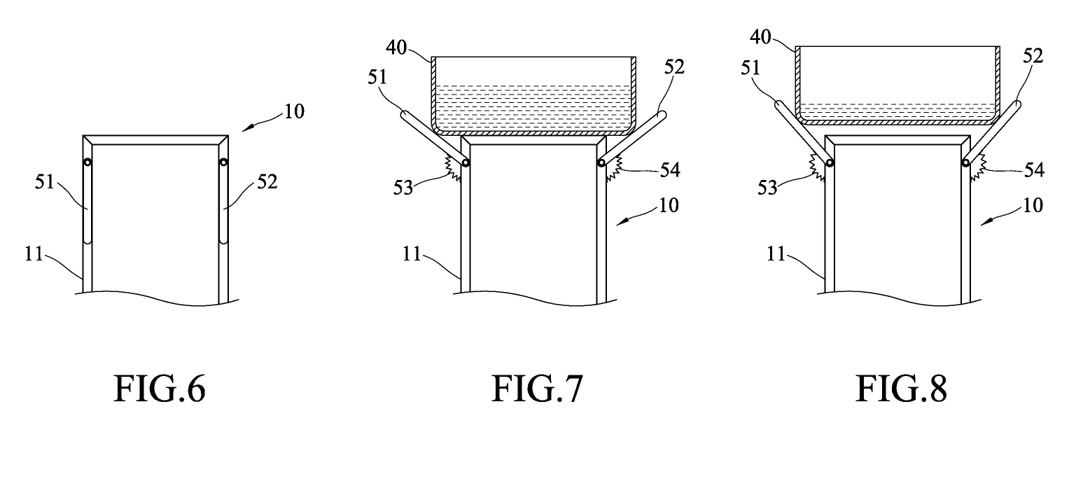

Referring to FIG. 6 through FIG. 8, diagrams schematically shows that a support device is added to a computer with an electric heating unit according to one embodiment of the present invention. In this embodiment, a support device is added to the casing 11 to prevent the heatable article 40 from being accidentally knocked over. The support device includes a first support member 51 and a second support member 52 respectively arranged on both sides of the casing 11 to hold the heatable article 40 placed on the flat plane 12.

The first support member 51 and the second support member 52 are respectively pivotally connected to two sides of the casing 11. When not in use, the first support member 51 and the second support member 52 are respectively folded in a closed position, as shown in FIG. 6. When the heatable article 40 is placed on the electric heating plane 21, the first support member 51 and the second support member 52 are respectively moved to a supporting position to hold the heatable article 40 securely preventing the heatable article 40 be knocked over by an accidental bumps or shakes by an earthquake, as shown in FIG. 7. Thus the safety of the heatable article 40 is guaranteed.

In another embodiment, the support device further includes a first expanding member 53 and a second expanding member 54. The first and the second expanding members 53 and 54 may be but are not limited to elastic members shown in the drawings. In yet another embodiment, the first and second expanding members 53 and 54 are oil hydraulic members or pneumatic members.

Referring to FIG. 8, one end of the first expanding member 53 is coupled to the casing 11, and the other end of the first expanding member 53 is coupled to the first support member 51, whereby the first support member 51 can be expanded. One end of the second expanding member 54 is coupled to the casing 11, and the other end of the second expanding member is coupled to the second support member 52, whereby the second support member 52 can be expanded. When the contain inside the heatable article 40 is heated and gradually evaporated, the weight of the object is gradually decreased. To such an extent that the entire weight is unable to overcome the upward pushing force of the first and second expanding members 53 and 54, and makes the heatable article 40 lifted up by the upward pushing force of the first and second expanding members 53 and 54. Thus, the heatable article 40 is separated from the electric heating plane 21 lest the electric heating plane 21 keep on heating the heatable article 40. Such a design can prevent the heatable article 40 from being over heated in a dried state and causing accidents.

The embodiments described above are only to exemplify the present invention but not to limit the scope of the present invention. Any equivalent modification or variation according to the specification or the claims of the present invention is to be also included within the scope of the present invention.

What is claimed is:

1. A computer with an electric heating unit, comprising:
a computer unit having a casing with a flat plane;
an electric heating unit arranged inside said casing, electrically connected to said computer unit and having an electric heating plane, wherein said electric heating plane is arranged on said flat plane to heat a heatable article placed on said flat plane; and
a controller used to control an operation status of said electric heating unit.

2. The computer with an electric heating unit according to claim 1, wherein said electric heating unit is arranged below said flat plane, and wherein said flat plane has an opening receiving said electric heating unit and revealing said electric heating plane.

3. The computer with an electric heating unit according to claim 1, wherein said electric heating plane has an electromagnetic heating coil.

4. The computer with an electric heating unit according to claim 1, wherein said controller is arranged on said casing and electrically connected to said electric heating unit.

5. The computer with an electric heating unit according to claim 4, wherein said controller is arranged on said flat plane.

6. The computer with an electric heating unit according to claim 1, wherein said controller is a keyboard electrically connected to said computer unit.

7. The computer with an electric heating unit according to claim 1, wherein said controller is a wireless controller.

8. A computer with an electric heating unit, comprising:
a computer unit having a casing with a flat plane;
an electric heating unit arranged inside said casing, electrically connected to said computer unit and having an electric heating plane, wherein said electric heating plane is arranged on said flat plane to heat a heatable article placed on said flat plane;
a controller used to control an operation status of said electric heating unit; and
a support device including a first support member and a second support member respectively connected to two sides of said casing to hold said heatable article placed on said flat plane.

9. The computer with an electric heating unit according to claim 8, wherein said electric heating unit is arranged below said flat plane, and wherein said flat plane has an opening receiving said electric heating unit and revealing said electric heating plane.

10. The computer with an electric heating unit according to claim 8, wherein said electric heating plane has an electromagnetic heating coil.

11. The computer with an electric heating unit according to claim 8, wherein said controller is arranged on said casing and electrically connected to said electric heating unit.

12. The computer with an electric heating unit according to claim 11, wherein said controller is arranged on said flat plane.

13. The computer with an electric heating unit according to claim 8, wherein said controller is a keyboard electrically connected to said computer unit.

14. The computer with an electric heating unit according to claim 8, wherein said controller is a wireless controller.

15. The computer with an electric heating unit according to claim 8, wherein said first support member and said second support member can be moved relatively to said casing to a supporting position to hold said heatable article placed on said flat plane, and wherein said first support member and said second support member can also be moved to a closed position.

16. The computer with an electric heating unit according to claim 8, wherein said first support member and said second support member are pivotally coupled to said casing.

17. The computer with an electric heating unit according to claim 8, wherein said support device further comprises:
a first expanding member with one end thereof coupled to said casing and another end thereof coupled to said first support member for expanding said first support member; and
a second expanding member with one end thereof coupled to said casing and another end thereof coupled to said second support member for expanding said second support member.

18. The computer with an electric heating unit according to claim 17, wherein said first expanding member and said second expanding member are elastic members.

19. The computer with an electric heating unit according to claim 17, wherein said first expanding member and said second expanding member are oil hydraulic members.

20. The computer with an electric heating unit according to claim 17, wherein said first expanding member and said second expanding member are pneumatic members.
